(19) United States
(12) Patent Application Publication
(10) Pub. No.: US 2022/0170577 A1
(43) Pub. Date: Jun. 2, 2022

(54) Double Elbow Hydraulic Assembly

(71) Applicant: MANULI HYDRAULICS ITALIA S.R.L., Milano (IT)

(72) Inventor: Giuseppe Rusconi, Rivolta d'Adda (Cremona) (IT)

(21) Appl. No.: 17/456,928

(22) Filed: Nov. 30, 2021

(30) Foreign Application Priority Data
Dec. 2, 2020 (IT) 102020000029543

(51) Int. Cl. F16L 37/53; F16L 13/14

(52) U.S. Cl. CPC F16L 37/53; F16L 43/00; F16L 13/143

(57) ABSTRACT

An elbow fitting and a double elbow hydraulic assembly for high pressure hydraulic pipes, also above 400 bar are disclosed, in which the elbow fitting comprises a tubular body with a curved extent between a first end and a second end, in which the first end is configured for a connection with a high pressure pipe and the second end is configured for a coupling with a coupling element configured to allow a relative rotation between the second end and the coupling element.

### BACKGROUND OF THE INVENTION

The invention relates to an elbow hydraulic fitting and a double elbow hydraulic assembly.

Specifically, but not exclusively, the invention can be applied for high pressure hydraulic systems, for example greater than 400 bar, and with a high operating pressure bursting safety factor, for example 4:1.

One of the problems of the prior art, in the sector of high pressure hydraulic systems, in particular in the installation of hydraulic hoses, is the difficulty that the operator encounters when he has to install assemblies with double bends or double elbows, to orient the bends so that they are perfectly aligned on the specifications. This problem exists both in maintenance and distribution operations, also in original equipment lines. In this case, fitters are forced to make a significant effort to tighten the pipe in restricted spaces, or also to prepare a new assembly that is suitable for the application.

It is in particular noted that the operation of installing an assembly that has been assembled in an imprecise manner is very problematic because imprecise assembly can cause significant stress induced both inside the pipe fitting area and inside the structure of the pipe. This drawback can constitute a significant risk for applications, leading to undesired premature faults.

Further, replacing an assembly with a hose that has not been installed in a precise manner is a costly and laborious operation.

It is further emphasised that in the traditional process of installing an assembly with elbow fittings, in particular with a flanged fitting in a restricted space, if there is no precise fitting suitability for the ports of the hydraulic apparatus to which the assembly has to be connected, the operator has to force the pipe and create stress induced in the pipe to adapt the connection end, making the operation stressful and of dubious efficacy.

Another drawback consists in that according to the traditional pipe-assembly process, double elbow fitting units must be suitably measured, for example with a graphic or digital goniometer, to detect the relative orientation of the elbows. This operation is particularly delicate and requires high precision and has a high risk of error.

### SUMMARY OF THE INVENTION

One object of the invention is to obviate one or more of the aforesaid limits and drawbacks of the prior art.

One object of the invention is to provide an alternative elbow fitting solution to the prior art.

One object of the invention is to provide an alternative double elbow assembly to the prior art.

One advantage is to reduce or exclude the risk of stress induced inside the system that includes the elbow fitting.

One advantage of the invention is to facilitate the preparation and installation of pipes assembled with two elbow fittings.

One advantage is to achieve time saving during preparation of the assembly and installation thereof.

One advantage is to enable the direction of the axis of the elbow to be adjusted in the event of difficulty in the installing the assembly.

One advantage is to facilitate fitting of a hydraulic assembly including the fitting in an OEM (“Original Equipment Manufacturer”) line in the case of imprecise preparation of the original assembly.

One advantage is an ergonomic improvement, in virtue of the fact that the installation of a set with double bend connections is more practical and immediate. Other advantages are a relatively reduced risk of error in the fitting operation, a reduction in fitting time, saving of the cost of possible production of assemblies to replace imprecise assemblies.

One advantage is eliminating the need to measure the relative orientation of the two elbow fittings with (digital or graphic) goniometers, with time saving and simplification of the assembly process.

One advantage is to simplify the installation of assemblies with two elbows, also for difficult and complex configurations in which the relative orientation in the space between the axes of the two elbows is generally set by the design.

One advantage is to avoid the use of a rotatable fitting, connected to the elbow fitting, where such a rotatable fitting would have numerous drawbacks, being costly and bulky, also entailing the need for a seal surface in the connection and the risk of loosening because of vibrations.

These objects and advantages, and still others, are achieved by the assembly according to one or more of the claims set out below.

In one embodiment, an elbow fitting comprises a tubular body with a curved extent between a first end and a second end so as to form an elbow, said first end being configured for connection to a high pressure pipe, said second end comprising a quick axial coupling of the push-to-connect type with a coupling element by a thrust along an axis of said second end, said quick axial coupling of the push-to-connect type being configured to enable a relative rotation around said axis between said second end and said coupling element. The quick axial coupling of the push-to-connect type can permit, in particular, a rotation of said second end around said axis, so as to vary, also by only a few degrees, a relative angular orientation between said first end and said second end.

The coupling element may include, in particular, a male coupling element, for example a tubular insert configured for connection with a high-pressure pipe by crimping (or another irreversible connection).

The elbow fitting may comprise, in particular, a first flange on the first end and/or a second flange on the second end. The elbow fitting may comprise, in particular, an elbow with an angle of 45° or 90°, or with a different angle, for example equal to 22.5°, or equal to 30°, or equal to 60°, or equal to 110°, or equal to 135°, or equal to 180° (in the shape of U), or greater than 15°, or comprised between 15° and 90°, or comprised between 30° and 90°, or comprised between 45° and 90°, or comprised between 15° and 180°, or comprised between 30° and 180°, or comprised between 45° and 180°.

It is in particular observed that the quick axial coupling of the push-to-connect type is configured to enable rotations, also minimal, of the connection, so as to adjust the orientation in space of at least one of the terminal ends of the elbow.

The quick axial coupling of the push-to-connect type may be, in particular, an axial coupling with threadless coupling.

The terminal end of the elbow fitting may comprise, in particular, a flange-type end, a BSP (British Standard Pipe) fitting, a metric fitting, or other types of pipe end connections.

The elbow fitting may comprise, in particular, a connection end that is suitable for connection to a pipe by crimping (or other connection that irreversible and cannot be dismantled without destroying the connection itself), in which case the elbow fitting has the advantageous possibility of modifying, even only slightly, the direction of orientation in space of an elbow after the crimping operation.

The elbow fitting may be, in particular, designed for high hydraulic pressure, for example greater than 400 bar, with a high operating pressure bursting safety factor, for example equal to 4:1. The elbow fitting may be, in particular, designed with high resistance to fatigue and with seal performance that meets international specifications for hydraulic connectors.

### BRIEF DESCRIPTION OF THE DRAWINGS

The invention can be better understood and implemented with reference to the appended drawings that illustrate embodiments thereof by way of non-limiting example, in which:

FIG. 1 is a partially sectioned view of a first embodiment of an elbow fitting made according to the invention;

FIG. 2 is another view of the elbow fitting of FIG. 1;

FIG. 3 is a partially sectioned view of a second embodiment of an elbow fitting made according to the invention;

FIG. 4 is a side view of a double elbow assembly that includes two elbow fittings made according to the invention;

FIG. 5 is a side view from the left of FIG. 4;

FIG. 6 is a side view of a double elbow assembly made according to the invention;

FIG. 7 is a side view of another double elbow assembly made according to the invention.

### DETAILED DESCRIPTION

With reference to the aforesaid figures, 1 indicates overall a hydraulic elbow fitting for pipes. The elbow fitting 1 may be, in particular, configured to withstand pressure not below 100 bar, or 200 bar, or 300 bar, in particular greater than 400 bar, for example equal to about 420 bar.

The elbow fitting 1 may comprise, in particular, a tubular body with a first end 2 (for example a female end) and a second end 3 (for example a female end).

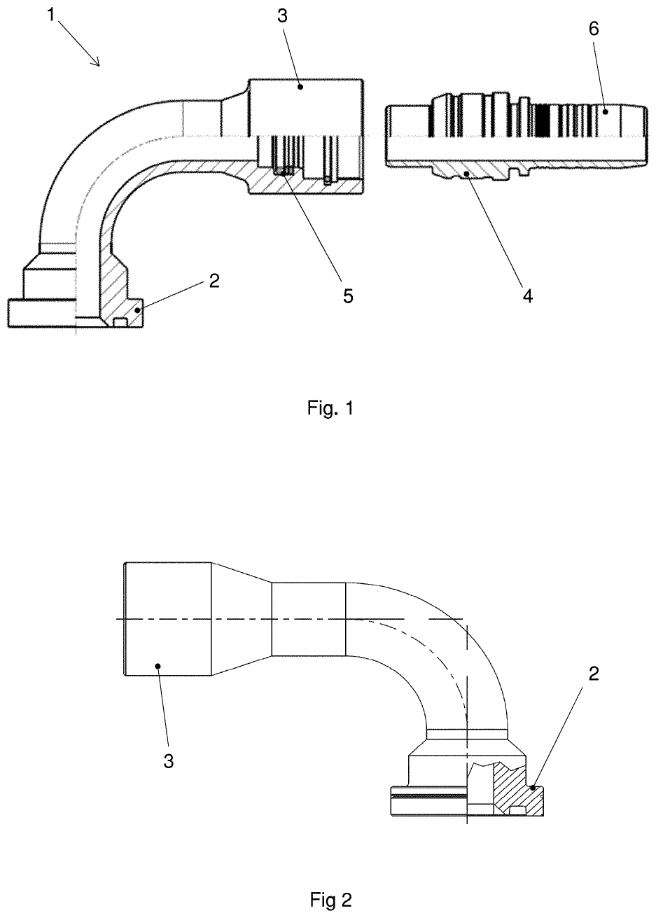

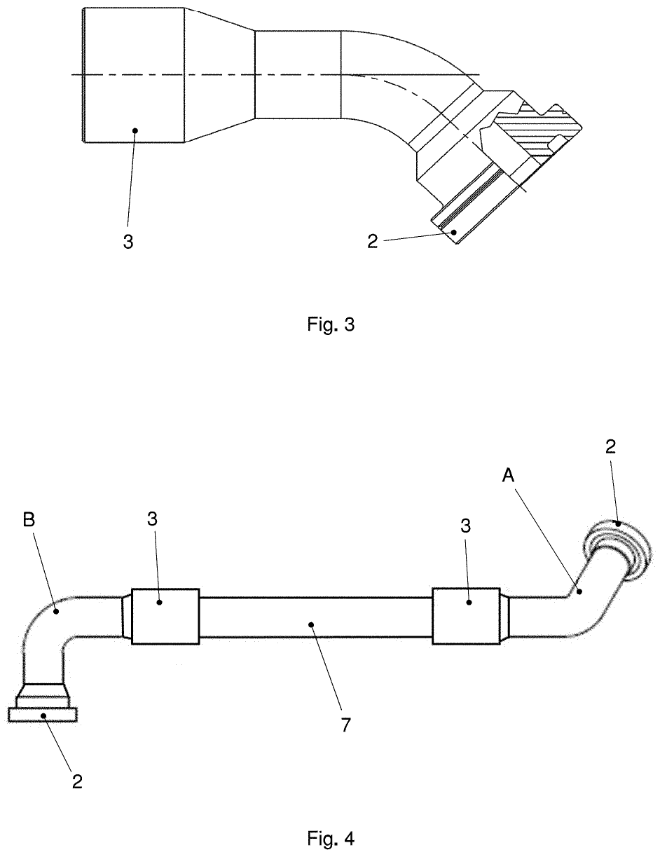

The tubular body can have, in particular, a curved extent (for example with a 90° elbow bend as in the embodiment of FIGS. 1 and 2, or 45° as in the embodiment of FIG. 3) between the first end 2 and the second end 3.

The tubular body, in particular, forms at least one elbow with a non-nil angle, for example greater than 15°, or greater than 22.5°, or greater than 30°. The angle of the elbow may be, in particular, comprised between 15° and 90° sexadecimal degrees, or comprised between 30° and 90° sexadecimal degrees, or comprised between 45° and 90° sexadecimal degrees, or comprised between 15° and 180° sexadecimal degrees, in particular equal to 15°, or 22.5°, or 30°, or 45°, or 60°, or 67,5°, or 75°, or 90°, or 110°, or 135°, or 180° (in the shape of U), etc.

It is further provided that the tubular body comprises, in particular, a special bent pipe according to a customized design.

The first end 2 may comprise, in particular, a first axis and the second end 3 may comprise, in particular, a second axis. The first axis and the second axis may be, in particular, non-aligned on one another. The first axis and the second axis may be, in particular, non-parallel to one another. The first axis and the second axis may be, in particular, incident (coplanar) to one another, as in the illustrated embodiments. In other embodiments that are not illustrated the first axis and the second axis may be, in particular, crooked (not coplanar) to one another.

The first end 2 may be configured, in particular, for a connection to a high pressure pipe. The first end 2 may comprise, in particular, a flanged fitting end, as in the illustrated embodiments. In other embodiments that are not illustrated the first end 2 may comprise, in particular, a British Standard Pipe connection, or a metric fitting, or a connection of another type.

The second end 3 may be configured, in particular, for a quick axial coupling of the push-to-connect type with a coupling element 4 (in particular with a male coupling element, as in the embodiments disclosed here) by an axial push along the second axis of the second end 3.

The quick axial coupling of the push-to-connect type may be configured, in particular, in order to permit a relative rotation of the second end 3 around the second axis (i.e. around the axis of the second end 3 and/or axis of the coupling element 4) with respect to the coupling element 4 (which in these embodiments has the form of a tubular insert). In particular, rotation is possible of the second end 3 around the second axis so as to vary a relative orientation in the space between the first end 2 and the second end 3. This relative orientation may be indicated as the angle formed by the axes of the first end 2 and of the second end 3.

The quick axial coupling of the push-to-connect type may comprise, in particular, the fitting known by the trade name FastFit that is manufactured by Manuli. The quick axial coupling of the push-to-connect type may comprise, in particular, a fitting like the fitting disclosed in patent publication EP 3462070 A1.

The quick axial coupling of the push-to-connect type is of the type that is suitable for quick installation by a simple axial thrust between the coupling elements. The quick axial coupling of the push-to-connect type may be, in particular, of the threadless type. The quick axial coupling of the push-to-connect type may comprise, in particular, a fitting activated by a male coupling element (in this case in the form of a tubular insert) that is pushed inside a female coupling element. The female coupling element may be constituted, in particular, by the second end 3 of the elbow fitting 1. The male coupling element may be constituted, in particular, by the tubular insert.

The second end 3 may comprise, in particular, an inner surface that is coaxial with the second axis. The second female end 3 may comprise, in particular, at least one sealing member 5 arranged on the aforesaid inner surface to make a seal on the (male) coupling element 4 inserted inside the inner surface. The second end 3 may comprise, in particular, at least one coupling member, for example of known type, configured to lock axially the coupling element 4 with respect to the inner surface, leaving a relative freedom of rotation motion (of at least a few degrees) of the second end 3 around the second axis with respect to the coupling element 4. The at least one coupling member may comprise, in particular, an elastic hooking ring, for example an elastic hooking ring like that disclosed in patent publication EP 3462070 A1, which is included here for reference.

Accordingly, the quick axial coupling of the push-to-connect type may comprise an inner surface that is coaxial with the second axis of the second end 3 and is provided with the at least one sealing member 5, which may comprise, for example, one or more annular seals that are each coaxial with the second axis of the second end 3.

The elbow fitting 1 may comprise, in particular, the coupling element 4, in the form of a tubular insert, which may be connected to the second end 3 of the fitting by the aforesaid quick axial coupling of the push-to-connect type.

The elbow fitting 1 may comprise, in particular, a detachable fitting like that disclosed in patent publication EP 3462070 A1, which is included here for reference, comprising a first fitting element, a second fitting element, at least one sealing member, an annular body, elastic means operating on the annular body, and an elastic hooking ring.

The coupling element 4 may comprise, as in this example, a crimping end 6 configured for connection by crimping (with plastic deformation) to a pipe (for example a hose).

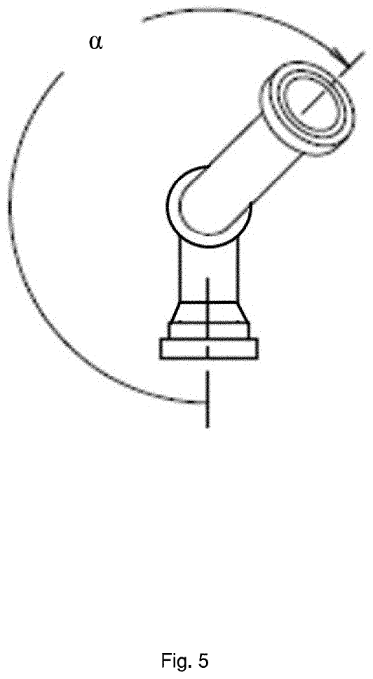

In FIG. 4 an embodiment is shown of a double elbow hydraulic assembly, for high pressure pipes. FIGS. 4 and 5 shows two different side views of the same assembly. The double elbow hydraulic assembly may comprise at least one first elbow A and at least one second elbow B.

The first elbow A may be made, in particular, of an elbow fitting 1 like that of FIG. 3 (as in the embodiment of FIG. 4) or of a fitting like that of FIG. 1, or in general of a fitting as disclosed and/or claimed here.

The second elbow B may be made, in particular, of an elbow fitting 1 like that of FIG. 1 (as in the embodiment of FIG. 4) or of a fitting like that of FIG. 3, or in general of a fitting as disclosed and/or claimed here.

The double elbow hydraulic assembly may comprise, in particular, a connection pipe 7 fixed to the coupling element 4 (tubular insert) of the first elbow A of the assembly. The connection pipe 7 may be, in particular, fixed to the coupling element 4 of the first elbow A by a crimping connection (by plastic deformation), i.e. a stable and irreversible connection, that is not removable without destroying the connection.

As said, the double elbow hydraulic assembly may comprise, in particular, a second elbow B fixed to the connection pipe 7.

The connection pipe 7 may be, in particular, fixed to the coupling element 4 of the second elbow B by a crimping connection (by plastic deformation), i.e. a stable and irreversible connection, that is not removable without destroying the connection.

The double elbow hydraulic assembly may comprise, in particular, a first male coupling element (for example like the coupling element 4) connected to a second end 3 of the first elbow A by the aforesaid quick axial coupling of the push-to-connect type, and a second male coupling element (for example like the coupling element 4) connected to a second end 3 of the second elbow B by the aforesaid quick axial coupling of the push-to-connect type.

The second end 3 of the second elbow B may be, in particular, coaxial with the second end 3 of the first elbow A.

The connection pipe 7 may be fixed, on one first side, to the first coupling element connected to the first elbow A, and on a second side (opposite the first side) to the to second coupling element connected to the second elbow B. The connection pipe 7 may be fixed, in particular, to each coupling element by a connection by plastic deformation, for example by a crimping connection.

The second end 3 of the second elbow B may be, in particular, provided with a second axis coaxial with an axis of the connection pipe 7. The second axis of the second end 3 of the second elbow B may be, in particular, coaxial with the second axis of the second end 3 of the first elbow A. In particular, the connection pipe 7 extends with a rectilinear longitudinal axis between the second end 3 of the first elbow A and the second end 3 of the second elbow B.

As has been said, each of the solutions disclosed above allows, for each elbow fitting, relative rotations between the coupling element 4 and the corresponding second end 3 of the elbow fitting 1, so as to enable the orientation of the elbow fitting 1 to be varied or adjusted. Such rotations, which can also be light or minimal (for example of a few degrees), can be sufficient for enabling the orientation of the elbow fitting 1 to be adapted.

In particular, it will be possible to modify the relative angular arrangement between the first end 2 and the second end 3 of each elbow fitting, where the first end 2 may be, in particular, the position coupled with a hydraulic element outside the assembly, and the second end 3 may be, in particular, the end coupled rotatably with the respective fitting element 4. This possibility of modification is very useful in the case of difficult and critical situations that may arise for the operator, especially in the installation step.

In the case of an assembly like that of FIGS. 4 and 5, it is possible to have relative rotations of the connection pipe 7 (connected in a non-removable manner to the second end 3 of the first elbow A on one side and to the second end 3 of the second elbow B on the opposite side), both with respect to the first elbow A and with respect to the second elbow B. These rotations may be, in particular, rotations around the longitudinal axis of the connection pipe 7, both the relative rotations with respect to the first elbow A and the relative rotations with respect to the second elbow B.

It is observed that in FIG. 5 a indicates the angle formed by the axes of the two first ends 2 of the two elbow fittings that are part of the assembly, a first end 2 that is part of the first elbow A and the other first end 2 forming part of the second elbow B.

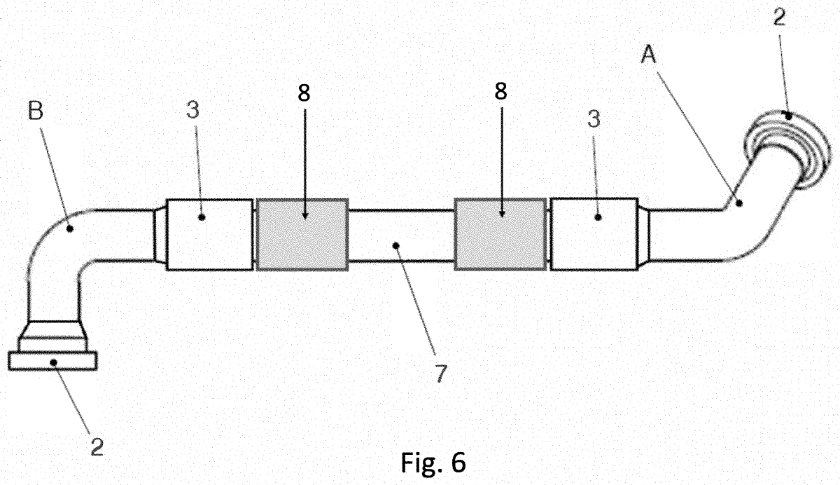

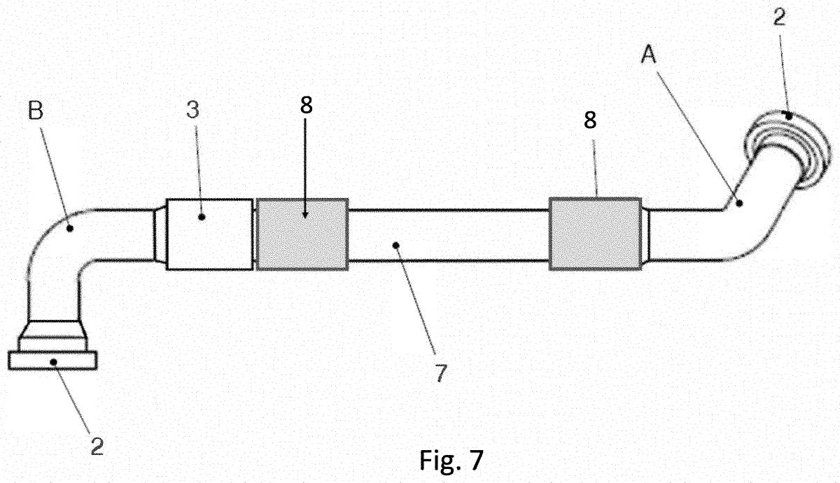

With reference to FIGS. 6 and 7, with 3 the aforementioned rotatable coupling has been indicated which allows said relative rotations between the two coupled elements, and with 8 the aforementioned permanent and irreversible connection has been indicated which connects the two connected elements in a fixed and stable manner.

Owing to the aforesaid possibility of relative rotations, it is possible to orient the elbows so that they are aligned perfectly on the specifics. Further, the risk of causing stress induced inside the double elbow assembly or inside the pipes connected to the assembly is reduced or practically excluded.

1. A double elbow hydraulic assembly, comprising:
a first elbow made by a hydraulic elbow fitting for high pressure pipes, said hydraulic elbow fitting comprising a tubular body with a first end and a second end and with a curved extent between said first end and said second end, said tubular body forming at least one elbow, said first end comprising a first axis and said second end comprising a second axis, said first axis and said second axis being not aligned with each other, said first end being configured for a high pressure connection, said second end being configured for an axial coupling with a first male coupling element configured to allow a relative rotation between said second end and said first coupling element around said second axis;
a first male coupling element connected to the second end of said first elbow by said axial coupling to allow a relative rotation between said second end and said first coupling element around said second axis;
a connection pipe fixed to said first male coupling element;
a second elbow made by a hydraulic elbow fitting for high pressure pipes, said hydraulic elbow fitting comprising a tubular body with a first end and a second end and with a curved extent between said first end and said second end, said tubular body forming at least one elbow, said first end comprising a first axis and said second end comprising a second axis, said first axis and said second axis not being aligned on one another, said first end being configured for a high pressure connection, said second end being connected to said connection pipe.

2. The hydraulic assembly of claim 1, wherein said second end of said first elbow comprises an internal surface coaxial to said second axis, at least one seal member arranged on said internal surface to seal on said first male coupling element inserted inside said internal surface, and at least one coupling member configured to axially lock said coupling element with respect to said internal surface leaving freedom of a rotation motion of said second end of said first elbow around said second axis with respect to said first male coupling element such as to vary a relative orientation between said first axis of said first end and said second axis of said second end.

3. The hydraulic assembly of claim 1, wherein said axial coupling comprises a quick axial coupling of push-to-connect type by a push along said second axis.

4. The hydraulic assembly of claim 1, wherein said first end of said first elbow comprises a flanged fitting end.

5. The hydraulic assembly of claim 1, wherein said first end of said second elbow comprises a flanged fitting end.

6. The hydraulic assembly of claim 1, wherein said first end of said first elbow comprises a British Standard Pipe or a metric fitting.

7. The hydraulic assembly of claim 1, wherein said first end of said second elbow comprises a British Standard Pipe or a metric fitting.

8. The assembly according of claim 1, wherein said first elbow forms an angle comprised between 15° and 180° sexadecimal degrees and said second elbow forms an angle comprised between 15° and 180° sexadecimal degrees.

9. The assembly according of claim 1, wherein said first elbow forms an angle comprised between 45° and 90° sexadecimal degrees and said second elbow forms an angle comprised between 45° and 90° sexadecimal degrees.

10. The hydraulic assembly of claim 1, comprising a second male coupling element connected to the second end of said second elbow, said connection pipe being fixed to said second coupling element by an irreversible connection.

11. The hydraulic assembly of claim 10, wherein said irreversible connection comprises a connection by plastic deformation by means of crimping.

12. The hydraulic assembly of claim 10, wherein said second end of said second elbow is coupled with an axial coupling with the second male coupling element to allow a relative rotation between said second end of said second elbow and said second coupling element around said second axis.

13. The hydraulic assembly of claim 1, wherein said connecting pipe is fixed to said first coupling element by means of an irreversible connection.

14. The hydraulic assembly of claim 13, wherein said irreversible connection comprises a connection by plastic deformation by means of crimping.
